(19) United States
(12) Patent Application Publication
(10) Pub. No.: US 2004/0262848 A1
(43) Pub. Date: Dec. 30, 2004

(54) Seal for a crankshaft housing

(76) Inventor: Bernd Meixner, Gunzenhausen (DE)

Correspondence Address: Howard & Howard Attorneys, The Pinehurst Office Center, Suite #101, 39400 Woodward Avenue, Bloomfield Hills, MI, 48304-5151, US

(21) Appl. No.: 10/466,658

(22) PCT Filed: Jan. 18, 2002
(86) PCT No.: PCT/DE02/00140

(30) Foreign Application Priority Data
Jan. 18, 2001 (DE) 101 01 915.7

(51) Int. Cl. B29C 45/00; F16J 15/32

(52) U.S. Cl. 277/549; 264/255; 264/328.1

(57) ABSTRACT

The invention relates to a seal (1) for shaft exiting a housing, comprising a support body (2) from injection-moldable plastic, a sealing element (3) from a polytetrafluoroethylene plastic compound for sealing the shaft, and an elastomer sealing body (4) formed onto the element for sealing the housing. The support body (2) consists of a duroplastic. The invention also relates to a method for producing such a seal.

The invention relates to a sealing for a housing with an outcoming shaft, with a substrate made of injection moldable plastic, with a sealing element made of a polytetrafluorethylene plastic compound for sealing the shaft and an attached elastomer sealing body to seal the housing as well as a process for manufacturing the sealing.

The sealing crankshaft in motor vehicles is done by a combination of dynamic and static sealings. The sealing of the shaft is done there by a shaft-sealing ring and the sealings for the cylinder crankshaft housing and for the oil pan is done by static sealings. These dynamic and static sealing methods have been integrated in one single substrate by increasing component integration. These kinds of substrate consist depending on the application of various materials.

EP 0139503 A2 shows for instance a substrate made of plastic. The sealing for the shaft and the housing is done by elastomer sealing elements. Alternatively the substrate can be made of tin, aluminum cast iron or other light metals. The elastomer sealing body is directly attached to a flange of the substrate.

It has now become evident that when the stress in the motor increases, as for example changing oil quantities and rising temperatures, elastomer sealings increasingly reach their operating limits. For this reason the sealing elements for the shaft are made of a polytetrafluorethylene (PTFE) compound.

EP 0615085 B1 shows just such a sealing concept. A PTFE sealing element is attached to a light metal die cast component. Since the sealing element is not however connected to the metal substrate without something further, it is necessary to connect the sealing element to the substrate using an elastomer body. This type of connection has the disadvantage that different materials have to be used just to connect the sealing element to the substrate, thus requiring several work steps, which drive manufacturing costs up.

In order to get a hold on this problem, the sealing element for sealing the shaft has been made of a PTFE compound which contains the material of the substrate as a compound component. DE 4442081 C2 has just such a sealing. The publication SEA Paper 970546 shows a substrate which is made in accordance with DE 4442081 C2. The substrate is composed of a thermoplastic material. Thermoplastics have the advantage that after the injection molding process no further work requires to be done to the product. Costs of tools and tool replacement costs are also small when compared to die cast tools. There are no interim steps in manufacturing a substrate in this way. The disadvantage of substrates made from thermoplastics is however that when the substrate is connected later to the crankshaft housing so-called inserts are needed. These are metal tubes which are poured into the thermoplastic body. The metal tubes serve to receive the mounting bolts and form a pressing limit when the bolds are tightened. Without the inserts the thermoplastic substrates cannot be functionally connected to the crankshaft housing.

The function of the invention is to improve generic sealing so that there is no need for the insert that have been customary up until now. In addition it will provide a kind of process that reduces manufacturing costs.

This function is fulfilled in the invention by the characteristics in the principal claim and by the process described in the subsidiary claim.

Advantageous designs of the invention are documented in the subsidiary claims.

The invention overcomes the previously held prejudice that for generic sealings only thermoplastic materials could be used. It has become evident that as regards its pressure resistance the substrate in the invention is so stable that connection to the crankshaft housing can be done without inserts. Although the substrate must be worked on after the injection process the manufacturing costs are lower than with thermoplastic substrates with injected inserts.

A design example of the invention is shown using diagrams and is described in more detail below.

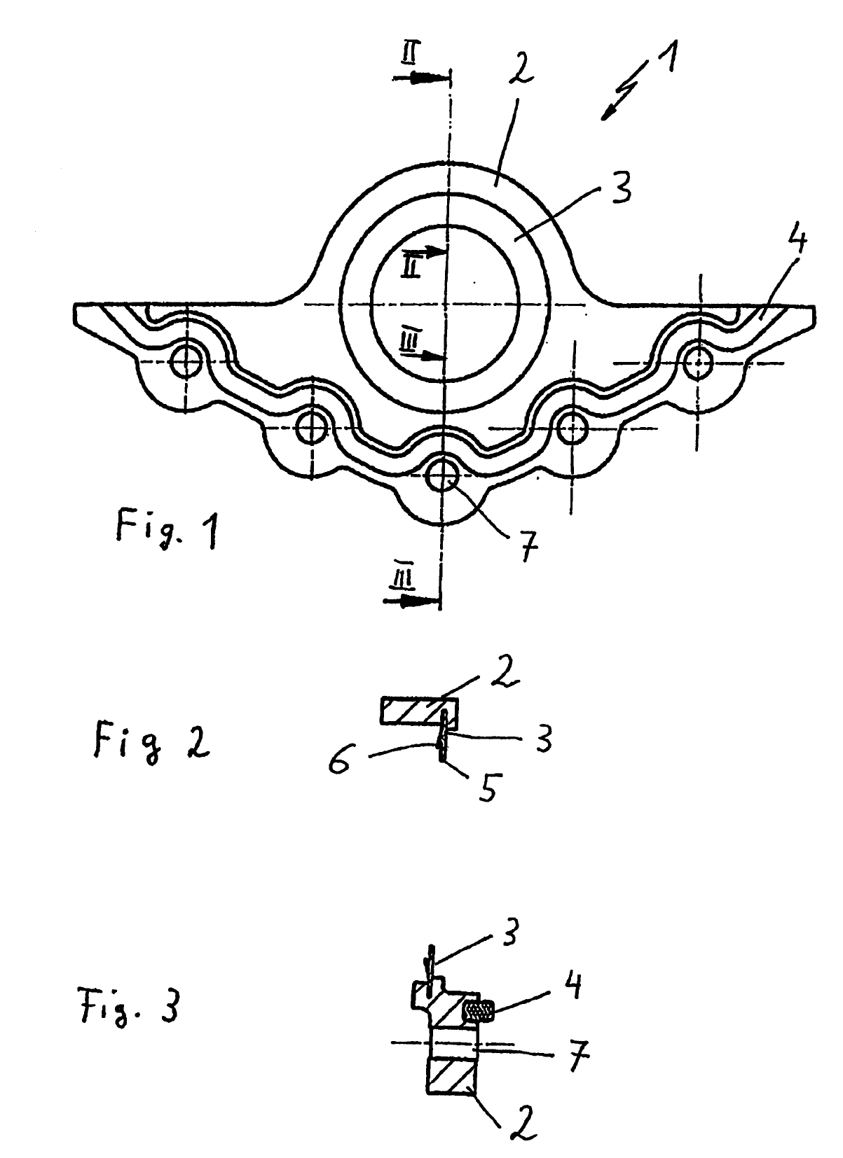

FIG. 1. View of a substrate described in the invention for sealing a crankshaft housing.

FIG. 2. View of line of intersection II-II of FIG. 1.

FIG. 3. View of line of intersection III-III of FIG. 1

FIG. 1 shows a sealing 1 for a housing (not shown) of combusion engines such as the crankshaft housing. The sealing consists of a substrate 2 made of modified thermosetting plastic. The shaft coming out of the housing is dynamically sealed via a sealing element 3 made of a polytetrafluorethylene compound. The sealing element 3 is designed as a disk and has a sealing lip 5 and a protective lip 6. The sealing lip 5 and the protective lip 6 can be made by splitting the disk. It is also possible to make the dynamic sealing elements of two separate disks. In its installed state the sealing lip 5 lies bent on the shaft that is to be sealed and takes on the task of liquid-sealing the housing. The protective lip 6 is only to keep dust off.

Static sealing for the housing is done by means of the sealing body 4 which is made of a rubber material.

As is evident from FIG. 2, the sealing element 3 is embedded in the thermosetting plastic substrate 2. For this it is necessary for the sealing element to be pretreated at least in the embedding area chemically or chemically/physically so that the thermosetting material connects with the PTFE sealing element 3.

FIG. 3 shows the configuration of the sealing body 4 on the substrate 2. The sealing body is injected on the thermoplastic of the substrate. The substrate 2 has many bores 7 for receiving the mounting bolts (not shown). With thermoplastic substrates metal tubes are normally poured into these bores 7. In the substrate 2 made of thermosetting plastic described in the invention the bores 7 do not have any inserts.

1-8. (Cancelled).

9. Process for manufacturing a sealing for a housing with an outcoming shaft, with a substrate made of injection moldable plastic, with a sealing element made of a polytetrafluorethylene plastic compound for sealing the shaft and an attached elastomer sealing body to seal the housing, wherein the sealing element is chemically or chemically/physically pre-treated and put into a tempered injection mold which serves to shape the substrate, and then a less than fully cured thermosetting plastic is put into the injection mold where it is shaped and cured, whereby the sealing element connects to the plastic.

10. Process as set forth in claim 9, wherein before injecting the sealing body, the substrate is put into another cavity or semi-cavity of the same tool or another tool.

11. A sealing for a housing with an outcoming shaft, with a substrate made of injection moldable plastic, with a sealing element made of a polytetrafluorethylene plastic compound for sealing the shaft and an attached elastomer sealing body to seal the housing, wherein the substrate comprises a thermosetting plastic and wherein the sealing body is chemically connected to the substrate.

12. Sealing as set forth in claim 11, wherein the plastic consists mainly of a phenol resin.

13. Sealing as set forth in claim 12, wherein the phenol resin is modified with elastomer material.

14. Sealing as set forth in claim 11, wherein the elastomer material consists of a material that is chemically similar to the sealing body.

15. Sealing as set forth in claim 11, wherein the elastomer material is selected from the group consisting of: acrylate, ethylene acrylate, fluor rubber, nitrile rubber and hydrated nitrile rubber.

16. Sealing as set forth in claim 11, wherein the sealing element comprises a radially split disk which form a sealing lip and a protective lip.

17. Sealing as set forth in claim 11, wherein the sealing element comprises two separated disks which form a sealing lip and a protective lip.
